(19) United States
(12) Patent Application Publication
(10) Pub. No.: US 2016/0216858 A1
(43) Pub. Date: Jul. 28, 2016

(54) METHOD AND PROGRAM PRODUCT FOR AN INTERACTIVE E-BOOK

(71) Applicant: Manzurul Khan, San Jose, CA (US)

(72) Inventor: Manzurul Khan, San Jose, CA (US)

(21) Appl. No.: 14/602,772

(22) Filed: Jan. 22, 2015

(51) Int. Cl. G06F 3/0483; G06T 13/20; G06F 3/0481; G09G 5/00; G06T 17/10; G06T 15/00; G06T 19/20

(52) U.S. Cl. CPC G06F 3/0483; G06T 15/005; G06T 13/20; G06T 19/20; G09G 5/003; G06T 17/10; G06F 3/04815; G09G 2380/14

(57) ABSTRACT

A method and program product comprises displaying a graphic area in a page of an e-book comprising a first three dimensional object being operative for animating and interacting. A first control object is displayed on the page. The first control object comprises a second three dimensional object being operative for animating and interacting for navigation to a next page in the e-book. A second control object on the page. The second control object comprises a third three dimensional object being operative for animating and interacting for navigation to a previous page in the e-book. A text area is displayed in the page.

### CROSS-REFERENCE TO RELATED APPLICATIONS

Not applicable

### RELATED CO-PENDING U.S. PATENT APPLICATIONS

Not applicable

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a graphical user interface (GUI). More particularly, the invention relates to an e-book interactive three-dimensional (3d) GUI animated graphic area with repeating frames, 3d text, and 3d navigational buttons.

### BACKGROUND OF THE INVENTION

The following background information may present examples of specific aspects of the prior art (e.g., without limitation, approaches, facts, or common wisdom) that, while expected to be helpful to further educate the reader, are not to be construed as limiting the present invention, or any embodiments thereof, to anything stated or implied therein or inferred thereupon.

An e-book is a digital version of a book that is readable in electronic devices. An e-book traditionally comprises texts and either still or animated images. There are numerous e-book formats available on the market. Also available are numerous software programs, which run in different hardware systems and which read and write these formats. The GUIs of the e-books use open-source software, which allows customization by users. Most of these e-books are designed with two-dimensional (2d) images that cannot handle continuous animation. While some images may be able handle 2d animation, those are simplistic 2d-animation forms. Some of the e-books have simple 3d animation, but they are not continuous, and the frames do not repeat. Prior approaches do not have interactive and repeating 3d animation which allows the images to move in x, y, or z direction. By having an interactive 3d animation with repeating frames in different locations of the e-book pages, the GUI will be helpful in explaining complex matters to children while making ebooks attractive to children through the continuous motion and interaction of the objects. Additionally, ebooks for adults may also be benefit by this innovation.

The following are examples of a specific aspects in the prior art that, while expected to be helpful to further educate the reader, are not to be construed as limiting the present invention, or any embodiments thereof, to anything stated or implied therein or inferred thereupon. One aspect of the prior art appears to disclose a multi-function system that features a menu, which may be ring shaped or wheel shaped and that is virtually rotatable in 3d space. By way of educational background, another aspect of the prior art generally useful appears to disclose a digital book that, in some embodiments, features an interactive 3d element that can display an interactive 3d image. It is believed that the user can provide touch input—by swiping, pinching or rotating—to spin, to enlarge, to shrink, or to rotate the 3d object. As a point of educational reference, such approaches may not provide a navigational 3d control objects that rotate on an x, y, or z axis or displaying animation objects as periodically spaced out graphics in an eBook or have continuous, repeating frames.

In view of the foregoing, it is clear that these approaches are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1I illustrate an exemplary device 100, in which FIG. 1A illustrates a GUI of the contents page, FIG. 1B illustrates a GUI with view/camera navigation page, FIG. 1C illustrates a GUI cover page, FIG. 1D illustrates a GUI review content page, FIG. 1E illustrates a GUI review page, FIG. 1F illustrates an add review page, FIG. 1G illustrates an exemplary navigation flow for FIGS. 1D-1F, and FIGS. 1H-1I illustrate a newly loaded page, in accordance with an embodiment of the present invention;

FIGS. 2A-2F illustrates an exemplary device 100, in which FIG. 2A illustrates a GUI with a full animated-graphic area, FIG. 2B illustrates a GUI with a horizontally split animated-graphic area, FIG. 2C illustrates a GUI with a vertically split animated-graphic area, FIG. 2D illustrates a GUI with an animated-graphic area at 75%, FIG. 2E illustrates a GUI in which the animated-graphic area is absent, and FIG. 2F illustrates a GUI with an animated-graphic area at 25%, in accordance with an embodiment of the present invention;

FIG. 3 is a flowchart of an exemplary method 300 for operating device 100, in accordance with an embodiment of the present invention;

FIG. 4 is a flowchart of an exemplary method 400 for interaction between the contents page and the chapter pages, in accordance with an embodiment of the present invention;

FIG. 5 is a flowchart of an exemplary method 500 illustrating the display of additional 3d interactive animated objects, in accordance with an embodiment of the present invention;

FIG. 6 is a flowchart of an exemplary method 600 illustrating the display explaining the 3d interactive animated objects, in accordance with an embodiment of the present invention;

FIG. 7 is a flowchart of an exemplary method 700 illustrating the interactive objects rotating on the animated-graphic area, in accordance with an embodiment of the present invention;

FIG. 8 is a flowchart of an exemplary method 800 illustrating the interactive angle and zoom functions, in accordance with an embodiment of the present invention;

FIG. 9 is a block diagram of an exemplary client/server system that may be used by an exemplary web-enabled/networked embodiment of the present invention;

FIG. 10 is a block diagram of a conventional client/server communication system; and

FIG. 11 illustrates an exemplary frame animation, in accordance with an embodiment of the present invention.

Unless otherwise indicated, illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 202.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

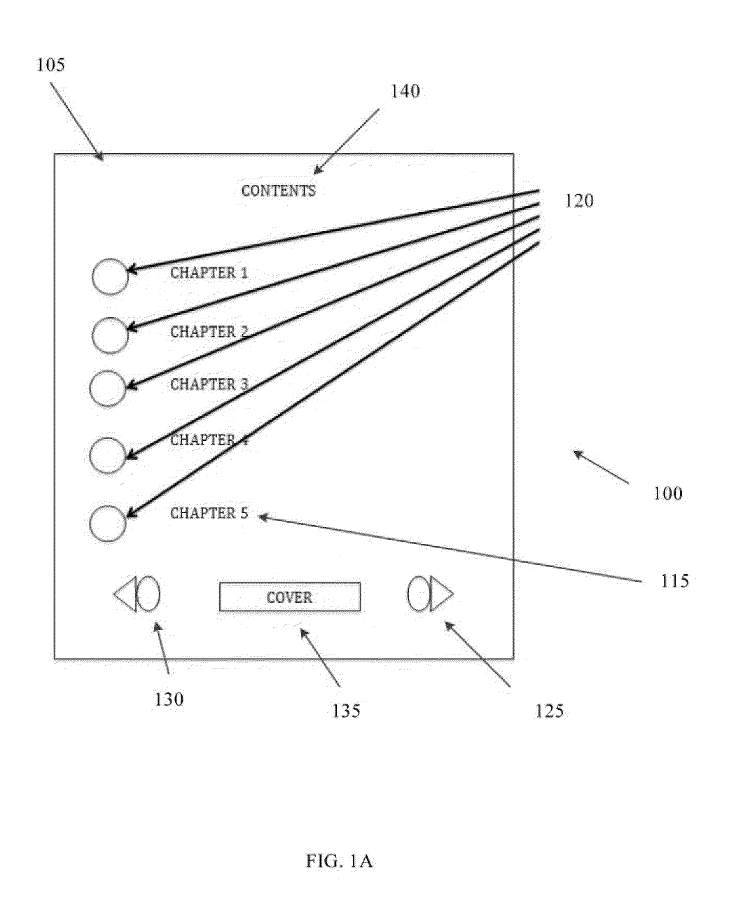

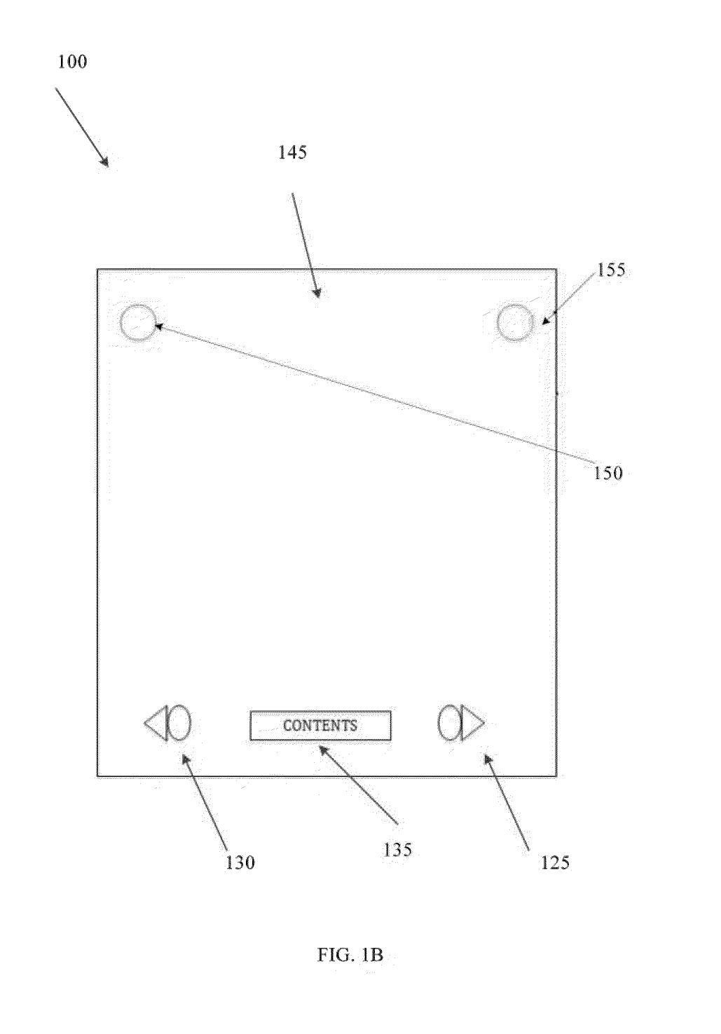

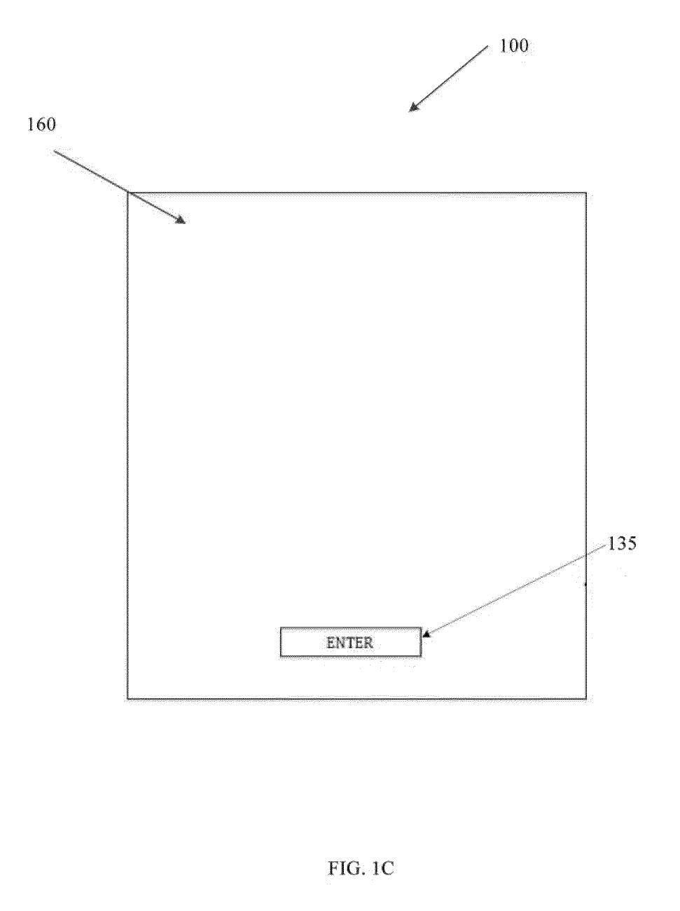

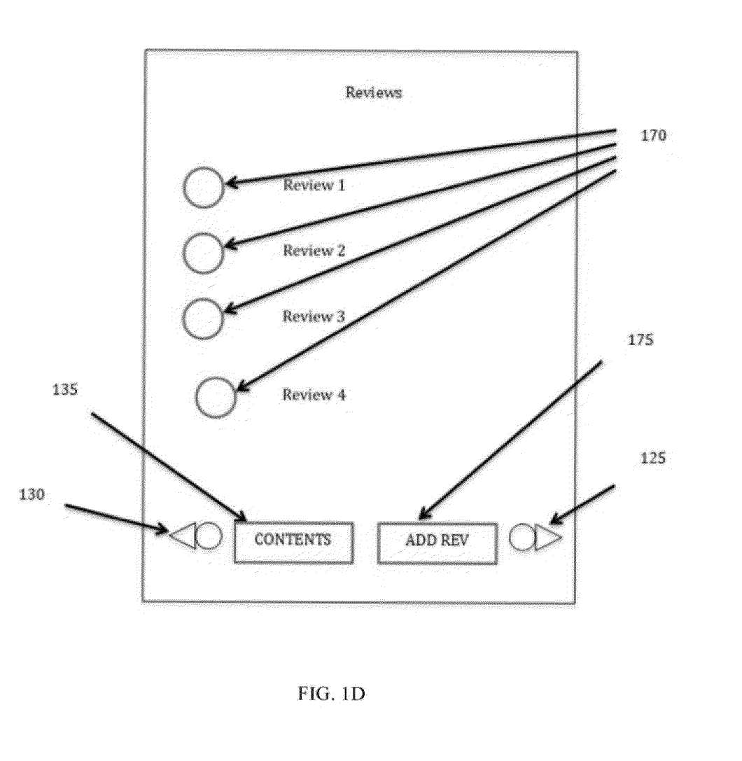

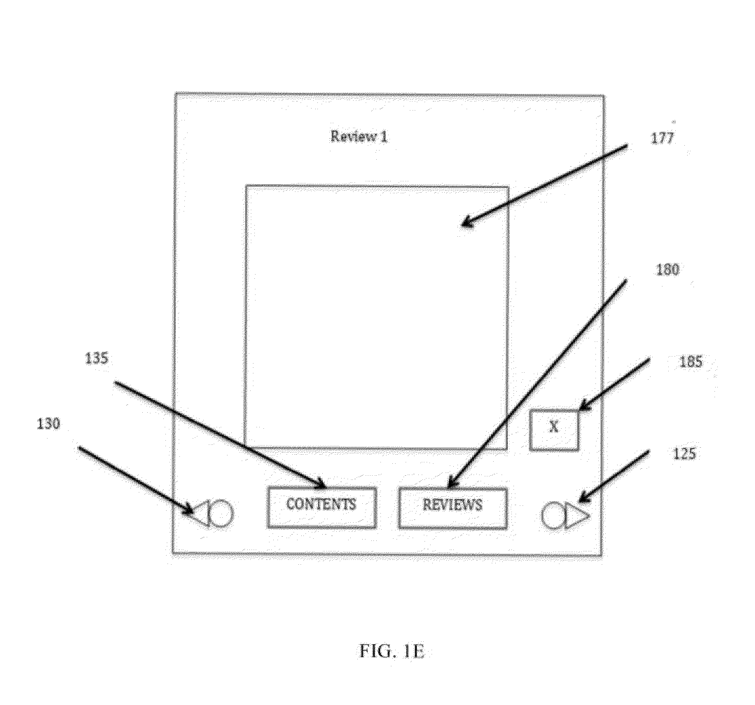

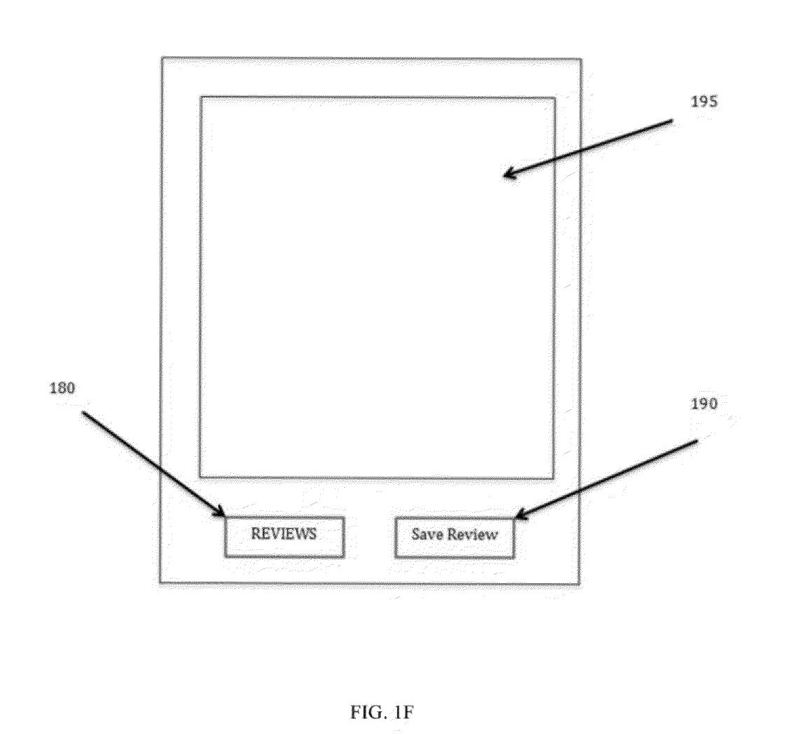

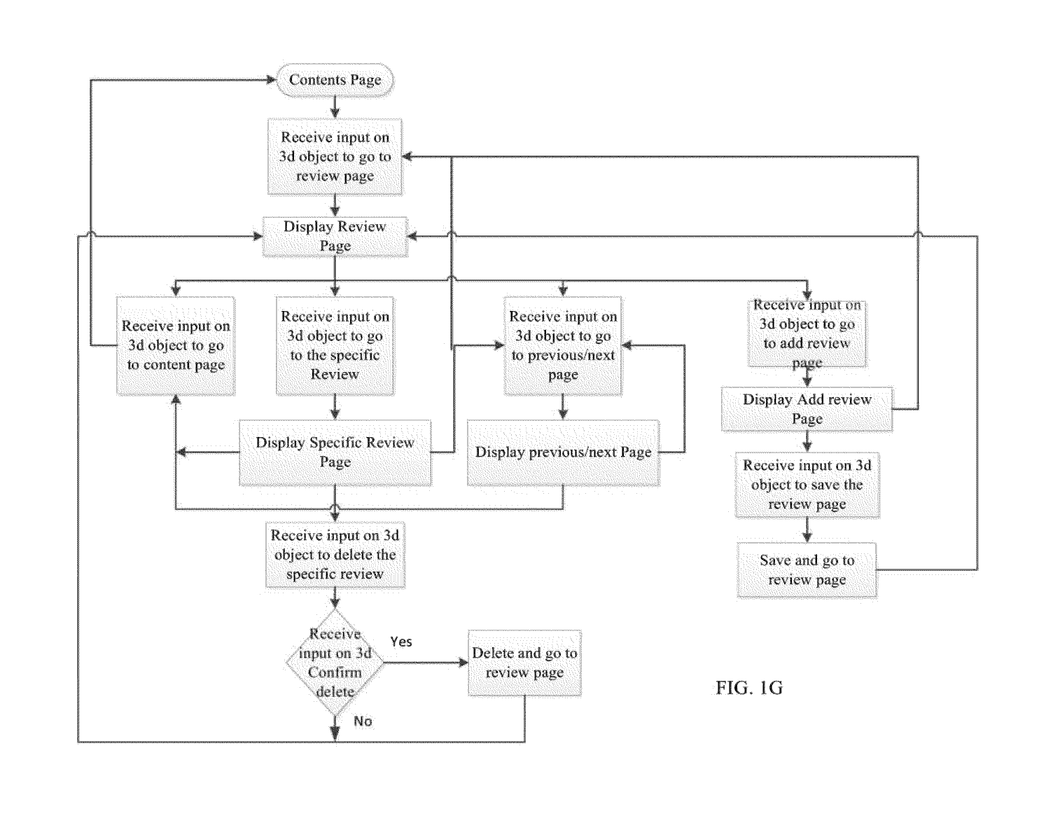

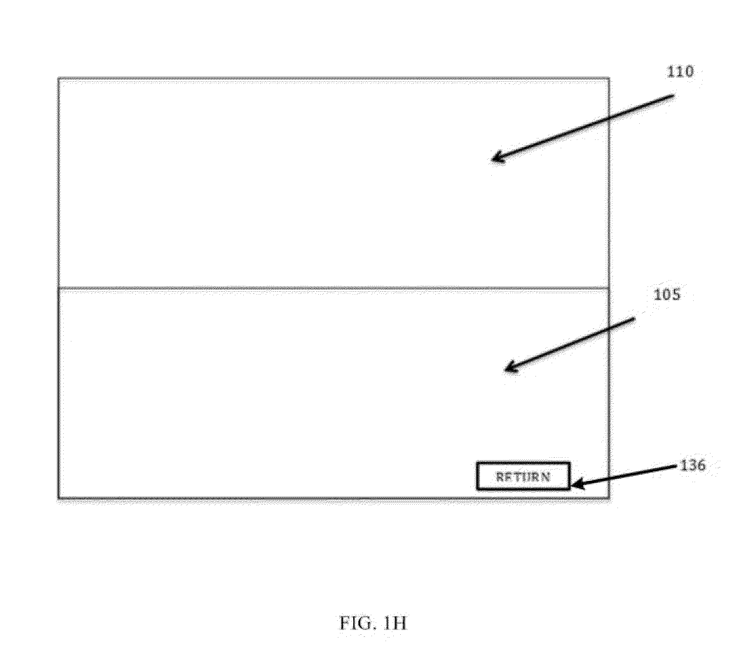

FIGS. 1A-1I illustrate an exemplary device 100, in which FIG. 1A illustrates a GUI of the contents page, FIG. 1B illustrates a GUI with view/camera navigation page, FIG. 1C illustrates a GUI cover page, FIG. 1D illustrates a GUI review content page, FIG. 1E illustrates a GUI review page, FIG. 1F illustrates an add review page, FIG. 1G illustrates an exemplary navigation flow for FIGS. 1D-1F, and FIGS. 1H-1I illustrate a newly loaded page, in accordance with an embodiment of the present invention. In the present embodiment, device 100 may have a GUI with a full animated-graphic area 105 that displays a contents page 140 containing, without limitation, one or more chapters 115. Each chapter 115 has an interactive 3d rotating objects 120 associated with it, and when selected, these images will load the related chapters 115.

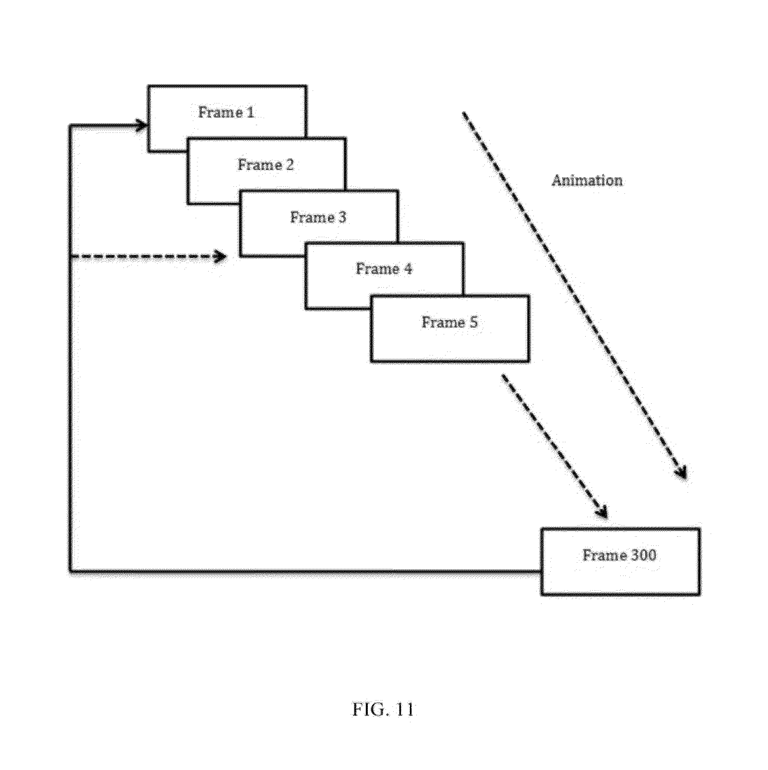

In the present embodiment, the animated-graphic area 105, which may display interactive 3d animations with repeating frames as shown in FIG. 11. In a non-limiting example, the frames may be set to repeat at specific intervals. In another non-limiting example, the interactive animation comprises objects that perform defined actions in response to user input. In another non-limiting example, the user may manipulate an animated object. In the present embodiment, the text area 110 of the device 100 may use either 2d or 3d and may allow text to move in any combination along the x, y, or z axes. In a non-limiting example, the text, similar to the graphics, may feature a topic that reflects the content of the e-book.

In the present embodiment, the navigational control button 125 is displayed pointed towards positive x axis as an intuitive impression of a directional navigation function via the shape of the control icon, in which the icon has a generally oblong shape terminating on one end with a generally more narrow ending to give the impression of a directional pointing, wherein the navigation function follows that visual direction as well. The navigational control button 125 is for navigating the book forward. In a non-limiting example, the shape of the navigational control button 125 may be similar to a sphere and a cone. In the present embodiment the navigational button 125 rotates along x axis. In a non-limiting example, when the user selects button 125, the 3d objects will start rotating randomly in all 3 directions and may change color upon selection. In the present embodiment, the 3d objects may comprise spheres and a cones. In other embodiments, the 3d objects may comprise one or more shapes that may give the impression of a direction or other function.

In the present embodiment, the navigational control button 130 is displayed pointed towards the negative x axis as an intuitive impression of a directional navigation function via the shape of the control icon, in which the icon has a generally oblong shape terminating on one end with a generally more narrow ending to give the impression of a directional pointing, wherein the navigation function follows that visual direction as well. The navigational control button 130 is for navigating the book backward. In a non-limiting example, the shape of the navigational control button 130 may be similar to a sphere and a cone. In the present embodiment the navigational button 130 rotates along x axis. In a non-limiting example, when the user selects button 130, the 3d objects will start rotating randomly in all 3 directions and may change color upon selection. In the present embodiment, the 3d objects may comprise spheres and a cones. In other embodiments, the 3d objects may comprise one or more shapes that may give the impression of a direction or other function.

In the present embodiment, the navigational control button 135 is displayed as an intuitive impression of a directional navigation function via the shape of the control icon, in which the icon has a generally solid object with two identical flat ends that are circular or elliptical and one curved side with the same cross-section from one end to the other. The navigational control button 135 is for navigating the book to different pages, including, without limitation, its contents page, cover page, review page, add review, save review, etc. In a non-limiting example, the shape of the navigational control button 135 may be similar to a cylinder. In the present embodiment the navigational button 135 rotates along x axis. In a non-limiting example, when the user selects button 135, the 3d objects will start rotating randomly in all 3 directions and may change color upon selection. In some embodiments, the 3d object may also be similar such as, but not limited to, capsule, cube or rectangular prism. In some embodiments, colors of the 3d object may be created by mixing a primary color in any combination. In some embodiments, the 3d object may have a texture. In some embodiments, the 3d object may have text specifying its functionality, for example, but not limited to, “Enter” which means enter the e-book, “content” which means go to contents, “save review” which means save user input, “display review” which means display the review.

In the present embodiment, the GUI view/camera navigation page 145 may contain, without limitation, 3d interactive rotating objects for the view/camera navigation button 150 and for the zoom in/out navigation button 155. In some embodiments, the view/camera navigation button may have “+” and “−” signs which may indicate if the button is for zoom in or out. In some embodiments, it may contain the word “rotate” or “r” or “any symbol to show rotate” to specify if it is for rotating the view. In a non-limiting example, the shape of the view/camera navigation button 150 and the zoom in/out navigation button 155 may be similar to a sphere. In some embodiments, it may also be a cube or a rectangular prism. In some embodiments, colors of this 3d object may be created by mixing a primary color in any combination. In some embodiments. the 3d object may have texture. In the present embodiment the view/camera navigation button 150 may allow the user to change the angle of the view. Moreover, in the present embodiment, the zoom in/out navigation button 155 may allow the user to zoom in and out. In some embodiments, this button may be used to zoom in/out the text as well.

In the present embodiment, the GUI cover page 160 may contain, without limitation, 3d interactive rotating object navigational control button 135.

FIG. 1D-1F illustrates an exemplary device 100, in which FIG. 1D illustrates a GUI of a review content page. In the present embodiment, buttons 170 may comprise 3d spheres. In other embodiments, other 3d shapes may be used. Upon selecting a button 170 or the text associated with it, a user may be able to navigate to a review page as shown in FIG. 1E. In the present embodiment, button 175 may comprise a 3d solid shape cylinder, capsule or rectangular prism. In other embodiments, other 3d shapes may be used. Upon selecting button 175, the user may be directed to add review page as shown in FIG. 1F.

FIG. 1E illustrates a GUI of a review page added by the user. In the present embodiment, button 185 comprises a 3d cube with sign x. Upon selecting this button, the user may be able to delete the review page, and then they may be navigated back to the review content page as shown in FIG. 1D. In some embodiments, before deletion, a confirmation window may pop up where user may need to confirm the delete action. In the present embodiment, area 177 may be the place where the review may appear.

FIG. 1F illustrates a GUI of an add review page. In the present embodiment, button 180 may comprise a 3d solid shape cylinder, capsule or rectangular prism. In other embodiments, other 3d shapes may be used. Upon selecting this button, the user may be directed to the review content page as shown in FIG. 1D. In the present embodiment, area 195 comprises a space where the user may be able to write their review before saving. In the present embodiment, button 190 comprises a 3d cylinder, capsule or rectangular prism. In other embodiments other 3d shapes may be used. In the present embodiment, upon selecting this button, the user may be able to save the review 195.

FIG. 1G illustrates an exemplary navigation flow for FIGS. 1D-1F. In the present embodiment, users may view, add and delete reviews. FIG. 1G illustrates how users may navigate among the review content page FIG. 1D, add review page FIG. 1F, view/delete review page FIG. 1E, and content page FIG. 1A. The user may navigate to the review content page FIG. 1D from main content page FIG. 1A by selecting 3d object 120 or text associated with it. From the review content page FIG. 1D, the user may have an option to go to content page FIG. 1D, add review FIG. 1F, view/delete review FIG. 1E or navigate backward or forward in page.

FIGS. 1H and 1I illustrates graphics of a newly loaded page. In the present embodiment, button 136 may be a 3d object comprising a cylinder, capsule or rectangular prism. In other embodiments, other 3d shapes may be used. Upon selecting the object 136, users may be taken back to an original page. In some embodiments, the button 136 may be located any place in the text view 110 or animation view place 105. In some embodiments, button 136 may have the text “RETURN”, “R”, or any symbol to specify that it is return button.

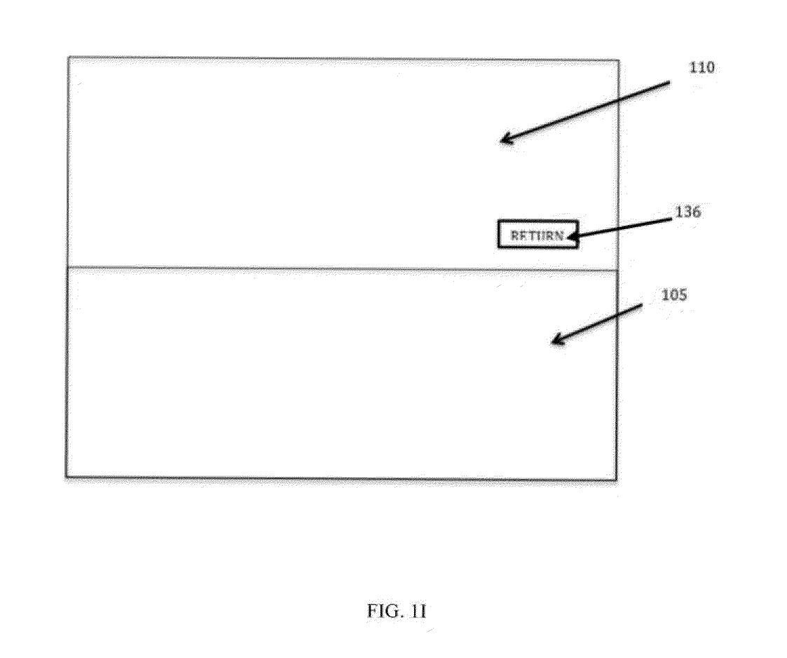

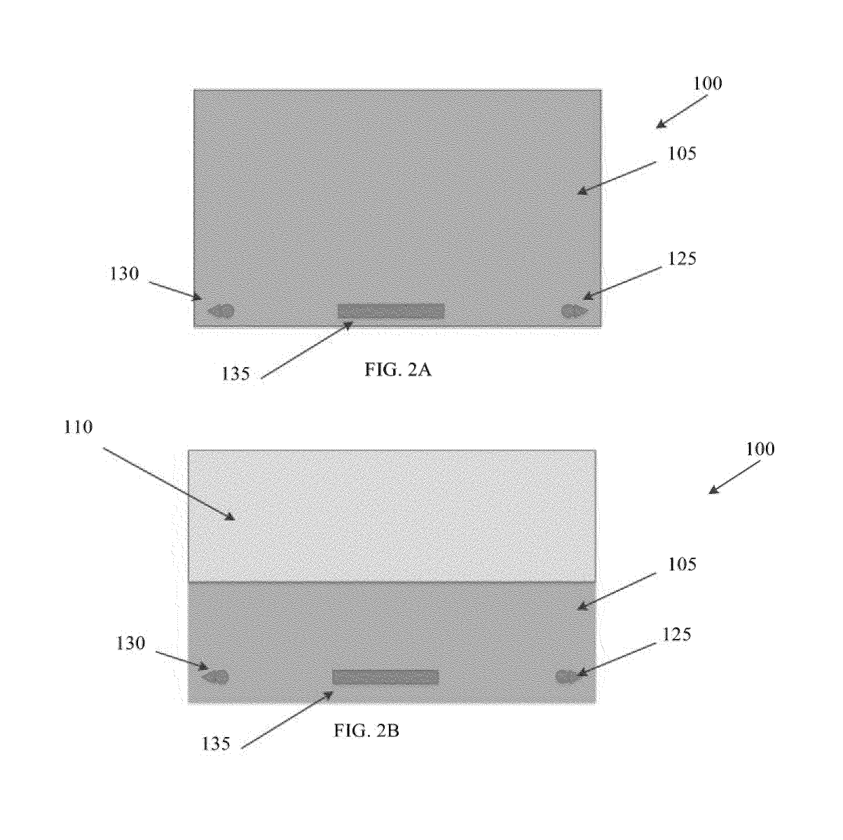

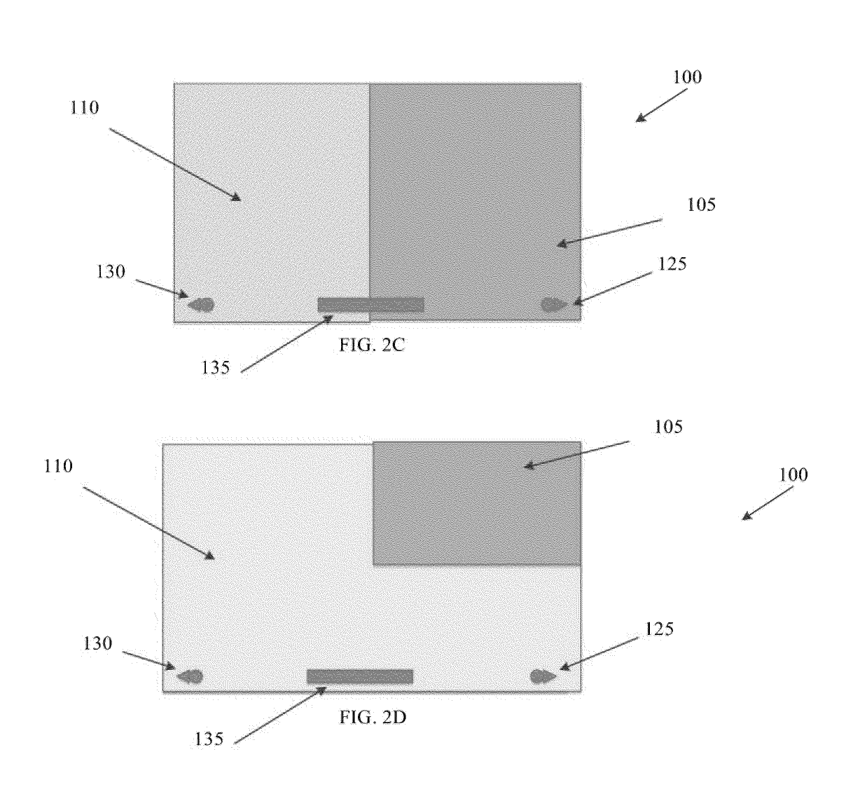

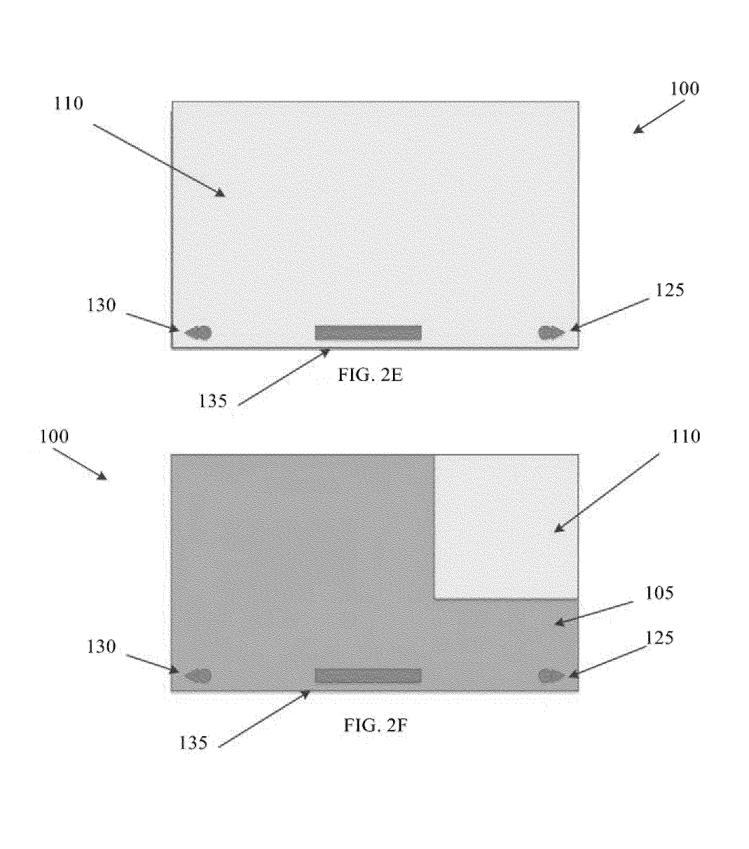

FIGS. 2A-2F illustrates an exemplary device 100, in which FIG. 2A illustrates a GUI with a full animated-graphic area, FIG. 2B illustrates a GUI with a horizontally split animated-graphic area, FIG. 2C illustrates a GUI with a vertically split animated-graphic area, FIG. 2D illustrates a GUI with an animated-graphic area at 75%, FIG. 2E illustrates a GUI in which the animated-graphic area is absent, and FIG. 2F illustrates a GUI with an animated-graphic area at 25%, in accordance with an embodiment of the present invention. In the present embodiment, device 100 may feature a variety of animated-graphic area 105 and text area 110 combinations, in which the animated-graphic area may display interactive 3d animations with repeating frames.

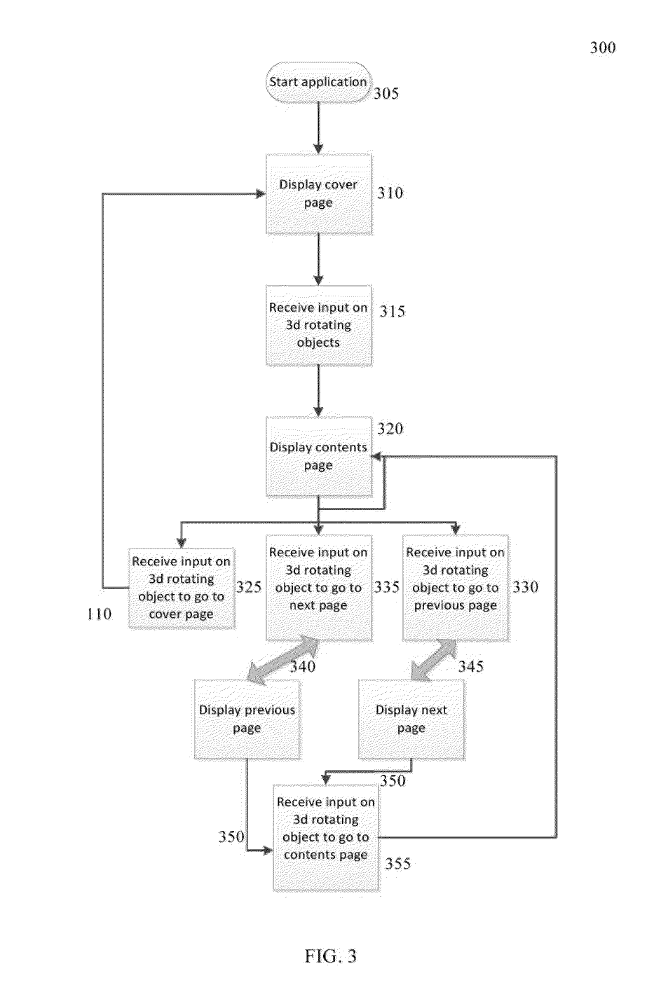

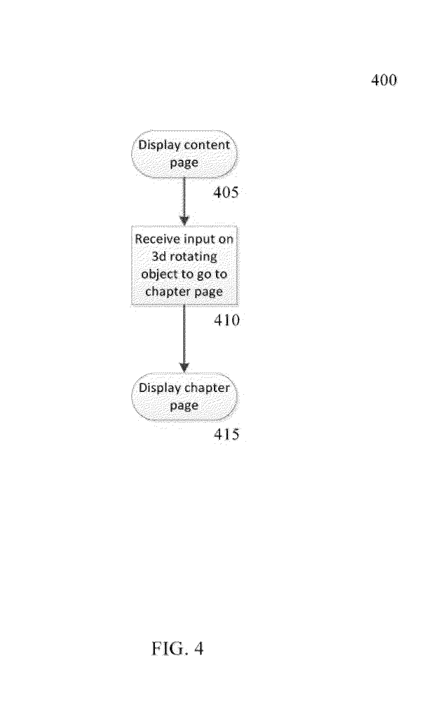

FIG. 3 is a flowchart of an exemplary method 300 for operating device 100, in accordance with an embodiment of the present invention. In the present embodiment, a user will start the application in a step 305. The application will display the cover page 160 in a step 310. The application waits, on the cover page 160, to receive an input on a 3d rotating object 135 in a step 315. In a non-limiting example, the user inputs may be generated from a keyboard, a mouse, or touch gestures. In the present embodiment, once the application receives an input, the application displays the contents page 140, in a step 320. Once on the contents page, the application waits to receive an input on 3d rotating object 135 to either go to the cover page 160, in a step 325, to display previous page via navigational button 130, in a step 330, or to display the next page via navigational button 125, in a step 335. Once the previous or next page is displayed, the application waits to receive an input to display previous page via navigational button 130, in a step 340, to display the next page via navigational button 125, in a step 345, or to go to the contents page 140, in a step 350. When the contents input is received, the user will be taken to the contents page, in a step 355. In the present embodiment, after first start 305 of the application, subsequent starts of the application may begin on the last viewed page.

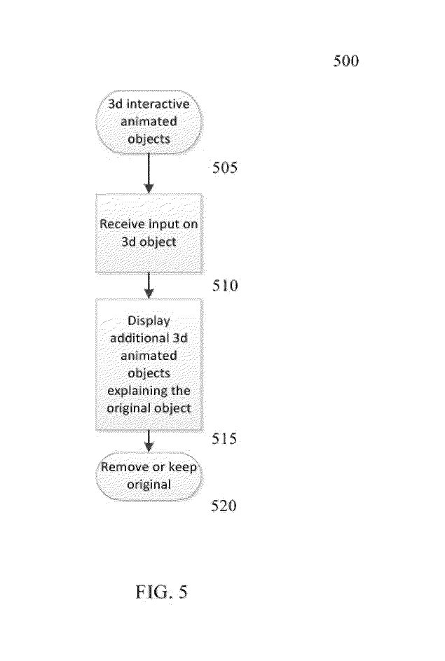

FIG. 4 is a flowchart of an exemplary method 400 for interaction between the contents page and the chapter pages, in accordance with an embodiment of the present invention. In the present embodiment, a user is able to interact between the contents page 140 and the chapter pages 115. The user may access the chapter through the content page 140 at a step 405. The application waits on the contact page 140 displaying the chapters 115 to receive an input on a 3d rotating object or the text associated with it in a step 410. In a non-limiting example, the user inputs may be generated from a keyboard, a mouse, or touch gestures. In the present embodiment, once the application receives an input, the application displays the requested chapter 115 in a step 415.

FIG. 5 is a flowchart of an exemplary method 500 illustrating the display of additional 3d interactive animated objects, in accordance with an embodiment of the present invention. In the present embodiment, the full animated-graphic area 105 enables a user to change between different illustrations in a step 505. The application waits on the device 100 to receive an input on a 3d object in the full animated-graphic area 105 in a step 510. In a non-limiting example, the user inputs may be generated from a keyboard, a mouse, or touch gestures. In the present embodiment, once the application receives an input, the application displays the additional 3d animated object explaining the original object, in a step 515. In some embodiments this may be similar to loading of a new page upon selecting the 3d object in the content page, except that the texts may or may not change. In a non-limiting example, there may be an original 3d interactive image of heart, and, when selected, the application will create another 3d image showing the view of heart dissected in middle. In the present embodiment, the user may then elect to remove or keep the original object, in a step 520.

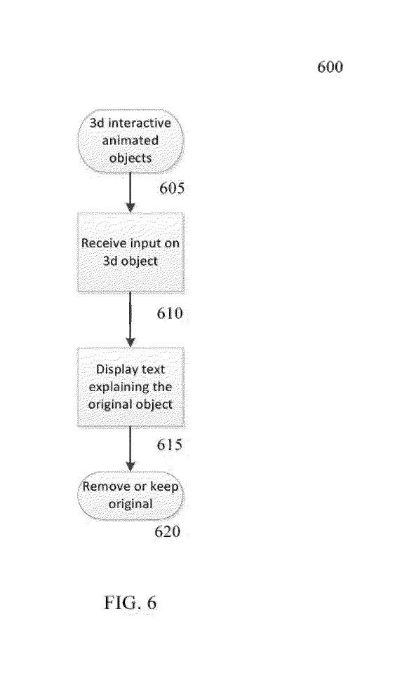

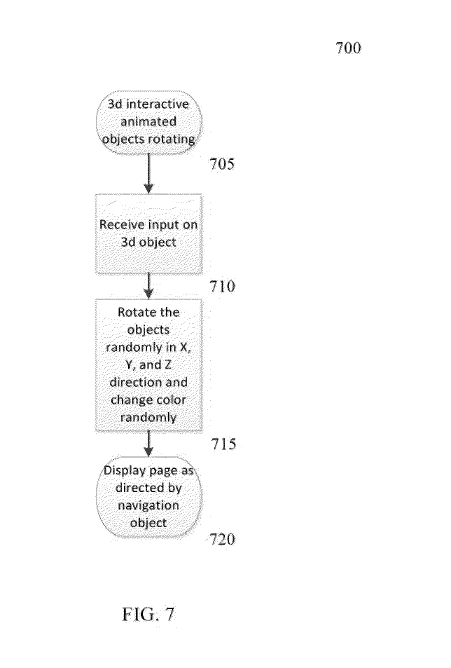

FIG. 6 is a flowchart of an exemplary method 600 illustrating the display explaining the 3d interactive animated objects, in accordance with an embodiment of the present invention. In the present embodiment, the full animated-graphic area 105 enables a user to change between different illustrations in a step 505. The application waits on the device 100 to receive an input on a 3d object in a step 605. In a non-limiting example, the user inputs may be generated from a keyboard, a mouse, or touch gestures. In the present embodiment, once the application receives an input, the application displays text explaining the 3d object, in a step 610. In some embodiments, this may be similar to loading a new page upon selecting the 3d object in contents page, except that the animation may or may not change. Button 136 is a 3d object comprising a cylinder, capsule or rectangular prism. In other embodiments, other 3d shapes may be used. Upon selecting the object 136, users may be taken back to original page. A user may then elect to remove or keep the original object, in a step 615.

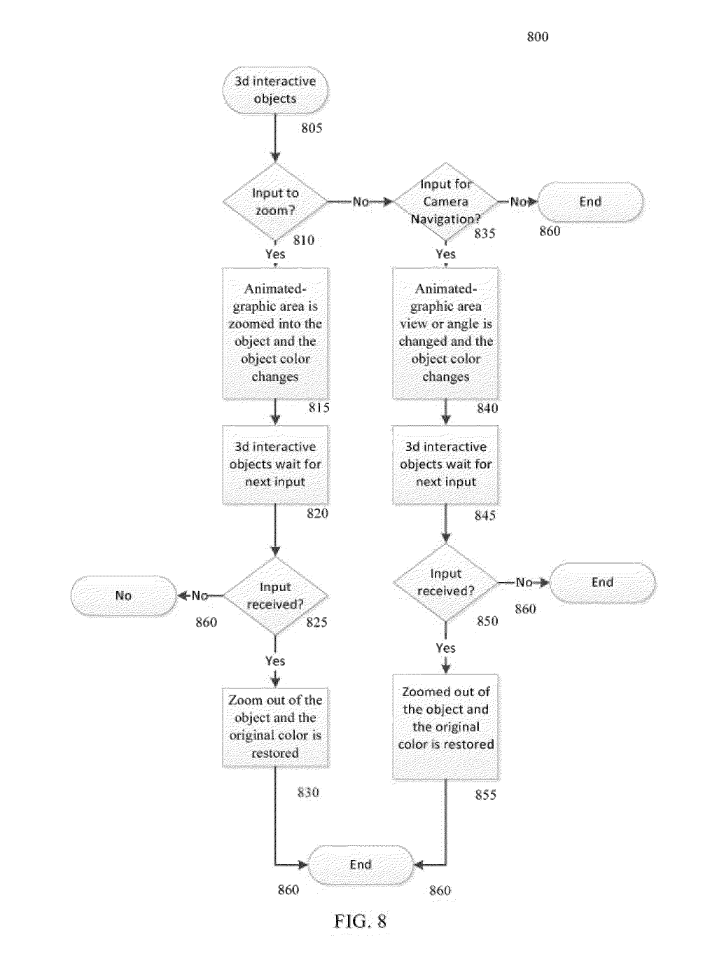

FIG. 7 is a flowchart of an exemplary method 700 illustrating the interactive objects rotating on the animated-graphic area, in accordance with an embodiment of the present invention. In the present embodiment, the interactive objects rotate on the animated-graphic area on the X, Y, or Z axis, in a step 705. In some embodiments, the object may rotate in any one direction or it may rotate in all two or three direction simultaneously. In a non-limiting example, interactive objects may be the navigational buttons 125, 130, and/or 135. In the present embodiment, the interactive objects, initially rotating in the X, Y, or Z direction receive an input on a 3d object in a step 710. In a non-limiting example, the user inputs may be generated from a keyboard, a mouse, or touch gestures. In the present embodiment, once the interactive objects receive an input, the objects randomly rotates in the X, Y, and Z directions and randomly changes color, in a step 715. In some embodiments, colors of this 3d object may be created by mixing a primary color in any combination. In some embodiments, the 3d object may have texture. The display page changes according to the navigational button input received, in a step 720.

FIG. 8 is a flowchart of an exemplary method 800 illustrating the interactive angle and zoom functions, in accordance with an embodiment of the present invention. In the present embodiment, the interactive objects on the view/camera navigation page 145 wait to receive input, in a step 805. If the objects receive an input to zoom from the navigational button 155 in a step 810, the animated-graphic area 105 is zoomed into the object and the object color changes to show that it is in a different view, in a step 815. In a non-limiting example, the user inputs may be generated from a keyboard, a mouse, or touch gestures. In the present embodiment, once the input is received and has zoomed, the interactive objects on the view/camera navigation page 145 wait to receive input, in a step 820. The objects receive an input to zoom from the navigational button 155 in a step 825. In a non-limiting example, the user inputs may be generated from a keyboard, a mouse, or touch gestures. In the present embodiment, once the input is received, the animated-graphic area 105 is zoomed out of the object, and the original color is restored to indicate no change in view, in a step 830. If, on the other hand, the objects receive an input for the camera navigation 150, in a step 835, the input triggers the animated-graphic area 105 to change view or position of the camera and changes the color of the 3d camera navigation object to show that it is now in a different view, in a step 840. In a non-limiting example, the user inputs may be generated from a keyboard, a mouse, or touch gestures. In the present embodiment, once the input is received and has changed angle or view, the interactive objects on the view/camera navigation page 145 wait to receive input, in a step 845. The objects receive an input to change view from the navigational button 160 in a step 850. In a non-limiting example, the user inputs may be generated from a keyboard, a mouse, or touch gestures. In the present embodiment, once the input is received, the animated-graphic area 105 is changed back to the original view and the color is restored to indicate no change in view, in a step 855.

FIG. 11 illustrates an exemplary frame animation, in accordance with an embodiment of the present invention. In the present embodiment, the animation may have 300 frames. Each frame may contain multiple 3d interactive objects. Playing frame 1 to 300 in time may create the animation effect. After frame 300, the animation may not stop. Instead, it may go back to frame 1 or any other previous frame and start playing the animation again. This way, user may always see a continuous animation in e-book page.

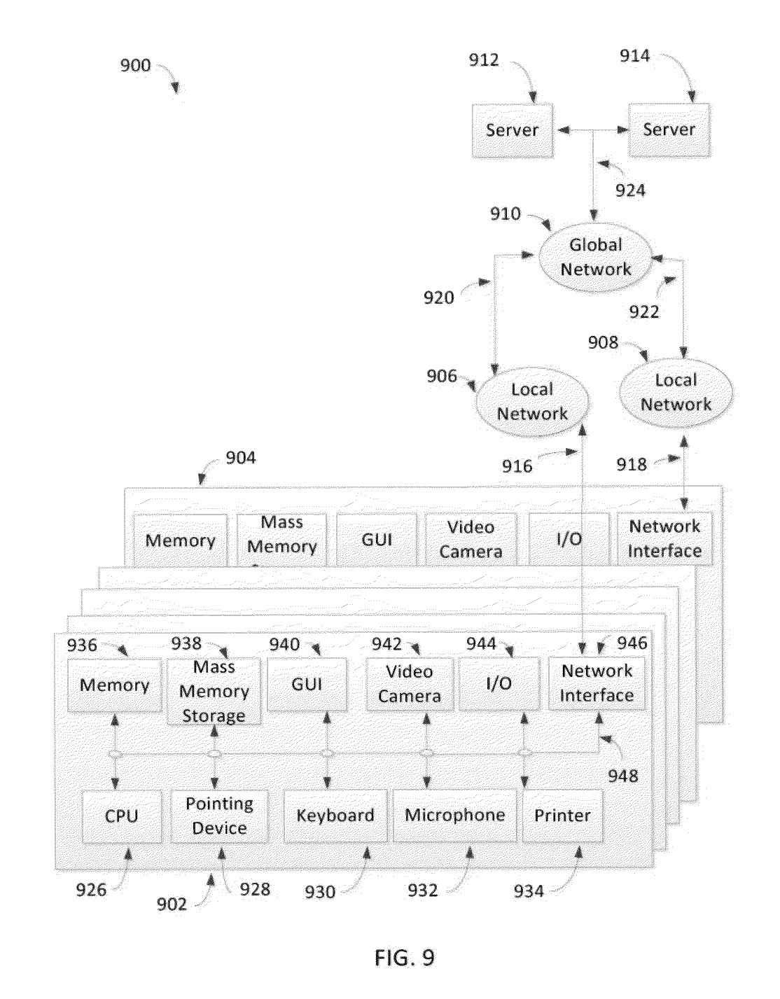

FIG. 9 is a block diagram of an exemplary client/server system that may be used by an exemplary web-enabled/networked embodiment of the present invention. A communication system 900 includes a multiplicity of clients with a sampling of clients denoted as a client 902 and a client 904, a multiplicity of local networks with a sampling of networks denoted as a local network 906 and a local network 908, a global network 910 and a multiplicity of servers with a sampling of servers denoted as a server 912 and a server 914.

Client 902 may communicate bi-directionally with local network 906 via a communication channel 916. Client 904 may communicate bi-directionally with local network 908 via a communication channel 918. Local network 906 may communicate bi-directionally with global network 910 via a communication channel 920. Local network 908 may communicate bi-directionally with global network 910 via a communication channel 922. Global network 910 may communicate bi-directionally with server 912 and server 914 via a communication channel 924. Server 912 and server 914 may communicate bi-directionally with each other via communication channel 924. Furthermore, clients 902, 904, local networks 906, 908, global network 910 and servers 912, 914 may each communicate bi-directionally with each other.

In one embodiment, global network 910 may operate as the Internet. It will be understood by those skilled in the art that communication system 900 may take many different forms. Non-limiting examples of forms for communication system 900 include local area networks (LANs), wide area networks (WANs), wired telephone networks, wireless networks, or any other network supporting data communication between respective entities.

Clients 902 and 904 may take many different forms. Non-limiting examples of clients 902 and 904 include personal computers, personal digital assistants (PDAs), cellular phones and smartphones.

Client 902 includes a CPU 926, a pointing device 928, a keyboard 930, a microphone 932, a printer 934, a memory 936, a mass memory storage 938, a GUI 940, a video camera 942, an input/output interface 944, and a network interface 946.

CPU 926, pointing device 928, keyboard 930, microphone 932, printer 934, memory 936, mass memory storage 938, GUI 940, video camera 942, input/output interface 944 and network interface 946 may communicate in a unidirectional manner or a bi-directional manner with each other via a communication channel 948.

Communication channel 948 may be configured as a single communication channel or a multiplicity of communication channels.

CPU 926 may be comprised of a single processor or multiple processors. CPU 926 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 936 is used typically to transfer data and instructions to CPU 926 in a bi-directional manner. Memory 936, as discussed previously, may include any suitable computer-readable media, intended for data storage, such as those described above excluding any wired or wireless transmissions unless specifically noted. Mass memory storage 938 may also be coupled bi-directionally to CPU 926 and provides additional data storage capacity and may include any of the computer-readable media described above. Mass memory storage 938 may be used to store programs, data and the like and is typically a secondary storage medium such as a hard disk. It will be appreciated that the information retained within mass memory storage 938, may, in appropriate cases, be incorporated in standard fashion as part of memory 936 as virtual memory.

CPU 926 may be coupled to GUI 940. GUI 940 enables a user to view the operation of computer operating system and software. CPU 926 may be coupled to pointing device 928. Non-limiting examples of pointing device 928 include computer mouse, trackball and touchpad. Pointing device 928 enables a user with the capability to maneuver a computer cursor about the viewing area of GUI 940 and select areas or features in the viewing area of GUI 940. CPU 926 may be coupled to keyboard 930. Keyboard 930 enables a user with the capability to input alphanumeric textual information to CPU 926. CPU 926 may be coupled to microphone 932. Microphone 932 enables audio produced by a user to be recorded, processed and communicated by CPU 926. CPU 926 may be connected to printer 934. Printer 934 enables a user with the capability to print information to a sheet of paper. CPU 926 may be connected to video camera 942. Video camera 942 enables video produced or captured by user to be recorded, processed and communicated by CPU 926.

CPU 926 may also be coupled to input/output interface 944 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 926 optionally may be coupled to network interface 946 which enables communication with an external device such as a database or a computer or telecommunications or internet network using an external connection shown generally as communication channel 916, which may be implemented as a hardwired or wireless communications link using suitable conventional technologies. With such a connection, CPU 926 might receive information from the network, or might output information to a network in the course of performing the method steps described in the teachings of the present invention.

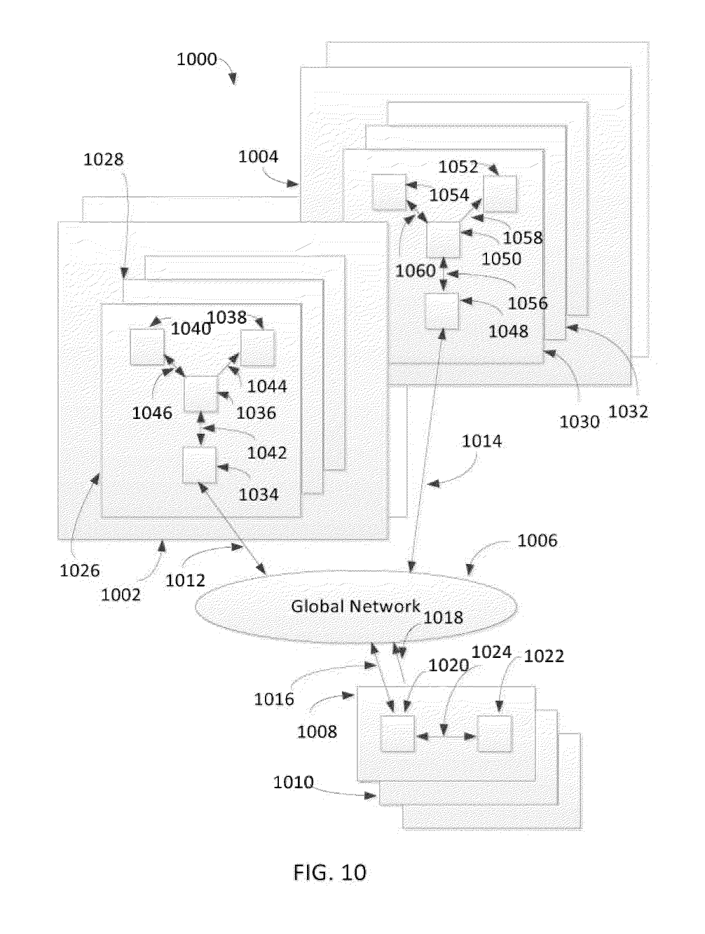

FIG. 10 is a block diagram of a conventional client/server communication system. A communication system 1000 includes a multiplicity of networked regions with a sampling of regions denoted as a network region 1002 and a network region 1004, a global network 1006 and a multiplicity of servers with a sampling of servers denoted as a server device 1008 and a server device 1010.

Network region 1002 and network region 1004 may operate to represent a network contained within a geographical area or region. Non-limiting examples of representations for the geographical areas for the networked regions may include postal zip codes, telephone area codes, states, counties, cities and countries. Elements within network region 1002 and 1004 may operate to communicate with external elements within other networked regions or within elements contained within the same network region.

In some implementations, global network 1006 may operate as the Internet. It will be understood by those skilled in the art that communication system 1000 may take many different forms. Non-limiting examples of forms for communication system 1000 include local area networks (LANs), wide area networks (WANs), wired telephone networks, cellular telephone networks or any other network supporting data communication between respective entities via hardwired or wireless communication networks. Global network 1006 may operate to transfer information between the various networked elements.

Server device 1008 and server device 1010 may operate to execute software instructions, store information, support database operations and communicate with other networked elements. Non-limiting examples of software and scripting languages which may be executed on server device 1008 and server device 1010 include C, C++, C# and Java.

Network region 1002 may operate to communicate bi-directionally with global network 1006 via a communication channel 1012. Network region 1004 may operate to communicate bi-directionally with global network 1006 via a communication channel 1014. Server device 1008 may operate to communicate bi-directionally with global network 1006 via a communication channel 1016. Server device 1010 may operate to communicate bi-directionally with global network 1006 via a communication channel 1018. Network region 1002 and 1004, global network 1006 and server devices 1008 and 1010 may operate to communicate with each other and with every other networked device located within communication system 1000.

Server device 1008 includes a networking device 1020 and a server 1022. Networking device 1020 may operate to communicate bi-directionally with global network 1006 via communication channel 1016 and with server 1022 via a communication channel 1024. Server 1022 may operate to execute software instructions and store information.

Network region 1002 includes a multiplicity of clients with a sampling denoted as a client 1026 and a client 1028. Client 1026 includes a networking device 1034, a processor 1036, a GUI 1038 and an interface device 1040. Non-limiting examples of devices for GUI 1038 include monitors, televisions, cellular telephones, smartphones and PDAs (Personal Digital Assistants). Non-limiting examples of interface device 1040 include pointing device, mouse, trackball, scanner and printer. Networking device 1034 may communicate bi-directionally with global network 1006 via communication channel 1012 and with processor 1036 via a communication channel 1042. GUI 1038 may receive information from processor 1036 via a communication channel 1044 for presentation to a user for viewing. Interface device 1040 may operate to send control information to processor 1036 and to receive information from processor 1036 via a communication channel 1046. Network region 1004 includes a multiplicity of clients with a sampling denoted as a client 1030 and a client 1032. Client 1030 includes a networking device 1048, a processor 1050, a GUI 1052 and an interface device 1054. Non-limiting examples of devices for GUI 1038 include monitors, televisions, cellular telephones, smartphones and PDAs (Personal Digital Assistants). Non-limiting examples of interface device 1040 include pointing devices, mousse, trackballs, scanners and printers. Networking device 1048 may communicate bi-directionally with global network 1006 via communication channel 1014 and with processor 1050 via a communication channel 1056. GUI 1052 may receive information from processor 1050 via a communication channel 1058 for presentation to a user for viewing. Interface device 1054 may operate to send control information to processor 1050 and to receive information from processor 1050 via a communication channel 1060.

For example, consider the case where a user interfacing with client 1026 may want to execute a networked application. A user may enter the IP (Internet Protocol) address for the networked application using interface device 1040. The IP address information may be communicated to processor 1036 via communication channel 1046. Processor 1036 may then communicate the IP address information to networking device 1034 via communication channel 1042. Networking device 1034 may then communicate the IP address information to global network 1006 via communication channel 1012. Global network 1006 may then communicate the IP address information to networking device 1020 of server device 1008 via communication channel 1016. Networking device 1020 may then communicate the IP address information to server 1022 via communication channel 1024. Server 1022 may receive the IP address information and after processing the IP address information may communicate return information to networking device 1020 via communication channel 1024. Networking device 1020 may communicate the return information to global network 1006 via communication channel 1016. Global network 1006 may communicate the return information to networking device 1034 via communication channel 1012. Networking device 1034 may communicate the return information to processor 1036 via communication channel 1042. Processor 1046 may communicate the return information to GUI 1038 via communication channel 1044. User may then view the return information on GUI 1038.

In some embodiments, the animated-graphic area 105 may be absent.

In some embodiments, the text area 110 may be absent.

In another embodiment, the interactive 3d animation with repeating frames may be used in web eBooks, games, or videos.

In another embodiment, the generally oblong shape terminating on one end with a generally narrower ending to give the impression of a directional pointing shape of navigational button 115 may rotate continuously along the x-axis.

In another embodiment, the generally oblong shape terminating on one end with a generally narrower ending to give the impression of a directional pointing shape of navigational button 120 may rotate continuously along the x-axis.

In another embodiment, the generally solid object with two identical flat ends that are circular or elliptical and one curved side with the same cross-section from one end to the other shape of navigational button 125 may rotate continuously along the x-axis.

In another embodiment, the device 100 may be useful in educational gaming products or web pages.

In another embodiment, the navigational buttons 115, 120, and 125 may be used in mobile devices by sliding the screen forward or backward to navigate the pages of device 100.

In some embodiments, the zoom in-out and camera angle could be changed by device specific gesture/input.

In an alternative embodiment, the navigational buttons 3d objects rotating in any of x, y or z axes may be used in mp3 players.

In accordance with the teaching of present invention, one of ordinary skill will readily realize that data in the spreadsheets may be formatted or sorted in a variety of ways. In some alternate embodiments, the spreadsheets may include additional information determined during the processing of the data. In some alternate embodiments, additional information may be included in the spreadsheets as hidden columns or rows where the user may choose to unhide the data columns or rows. In some other alternate embodiments, the spreadsheets may include a macro type program to assist the user in performing operations on the spreadsheets such as, but not limited to, sorting, formatting, searching, and further analysis.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: web site hosting and cloud storage for databases.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing an e-book interactive 3d GUI animated graphic area according to the present invention will be apparent to those skilled in the art. Various aspects of the invention have been described above by way of illustration, and the specific embodiments disclosed are not intended to limit the invention to the particular forms disclosed. The particular implementation of the e-book interactive 3d GUI animated graphic area may vary depending upon the particular context or application. By way of example, and not limitation, the e-book interactive 3d GUI animated graphic area described in the foregoing were principally directed to stimulate and teach complex problems to children implementations; however, similar techniques may instead be applied to adults or individuals, children and adults, with learning disabilities, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
displaying a graphic area in a page of an e-book, said graphic area at least comprising a first three dimensional object, said first three dimensional object being operative for a first animating, said first animating repeating while during displaying of said graphic area, said first three dimensional object further being operative for interacting, said interacting at least comprising being selectable wherein a selecting of said first three dimensional object enables a second animating of said first three dimensional object;
displaying a first control object on said page, said first control object at least comprising a second three dimensional object, said second three dimensional object being operative for a first animating, said first animating at least comprising a rotation about an axis, said second three dimensional object further being operative for interacting, said interacting at least comprising being selectable wherein a selecting of said second three dimensional object enables a navigation to a next page in said e-book;
displaying a second control object on said page, said second control object at least comprising a third three dimensional object, said third three dimensional object being operative for a first animating, said first animating at least comprising a rotation about an axis, said third three dimensional object further being operative for interacting, said interacting at least comprising being selectable wherein a selecting of said third three dimensional object enables a navigation to a previous page in said e-book; and
displaying a text area in said page.

2. The method as recited in claim 1, further comprising the step of:
displaying a third control object on said page, said third control object at least comprising a fourth three dimensional object, said fourth three dimensional object being operative for a first animating, said first animating at least comprising a rotation about an axis, said fourth three dimensional object further being operative for interacting, said interacting at least comprising being selectable wherein a selecting of said fourth three dimensional object enables a navigation to a section of said e-book.

3. The method as recited in claim 2, in which said first animating of said second three dimensional object, third three dimensional object, and fourth three dimensional object comprises a rotation about an x axis of said page.

4. The method as recited in claim 1, in which said second three dimensional object and said third three dimensional object further comprise a shape indicating a directionality.

5. The method as recited in claim 4, in which said shape further comprises a sphere and a cone.

6. The method as recited in claim 2, in which said fourth three dimensional object further comprises a generally cylindrical shape.

7. The method as recited in claim 1, in which said selecting of said second three dimensional object further enables a second animating at least comprising a rotation about one or more other axis, and a selecting of said third three dimensional object further enables a second animating at least comprising a rotation about one or more other axis.

8. The method as recited in claim 2, in which a selecting of said fourth three dimensional object further enables a second animating at least comprising a rotation about one or more other axis.

9. The method as recited in claim 1, in which said text area further comprises three dimensional text further being operative for interacting, said interacting at least comprising being selectable.

10. A method comprising:
steps for displaying a first three dimensional object in a graphic area in a page of an e-book;
steps for displaying a first control object on said page for navigating to a next page in said e-book;
steps for displaying a second control object on said page for navigating to a previous page in said e-book; and
steps for displaying a text area in said page.

11. The method as recited in claim 10, further comprising:
steps for displaying a third control object on said page for navigating to a previous page in said e-book.

12. A non-transitory computer-readable storage medium with an executable program stored thereon, wherein the program instructs one or more processors to perform the following steps:
displaying a graphic area in a page of an e-book, said graphic area at least comprising a first three dimensional object, said first three dimensional object being operative for a first animating, said first animating repeating while during displaying of said graphic area, said first three dimensional object further being operative for interacting, said interacting at least comprising being selectable wherein a selecting of said first three dimensional object enables a second animating of said first three dimensional object;
displaying a first control object on said page, said first control object at least comprising a second three dimensional object, said second three dimensional object being operative for a first animating, said first animating at least comprising a rotation about an axis, said second three dimensional object further being operative for interacting, said interacting at least comprising being selectable wherein a selecting of said second three dimensional object enables a navigation to a next page in said e-book;
displaying a second control object on said page, said second control object at least comprising a third three dimensional object, said third three dimensional object being operative for a first animating, said first animating at least comprising a rotation about an axis, said third three dimensional object further being operative for interacting, said interacting at least comprising being selectable wherein a selecting of said third three dimensional object enables a navigation to a previous page in said e-book; and
displaying a text area in said page.

13. The program instructing the one or more processors as recited in claim 12, further comprising the step of:
displaying a third control object on said page, said third control object at least comprising a fourth three dimensional object, said fourth three dimensional object being operative for a first animating, said first animating at least comprising a rotation about an axis, said fourth three dimensional object further being operative for interacting, said interacting at least comprising being selectable wherein a selecting of said fourth three dimensional object enables a navigation to a section of said e-book.

14. The program instructing the one or more processors as recited in claim 13, in which said first animating of said second three dimensional object, third three dimensional object, and fourth three dimensional object comprises a rotation about an x axis of said page.

15. The program instructing the one or more processors as recited in claim 12, in which said second three dimensional object and said third three dimensional object further comprise a shape indicating a directionality.

16. The program instructing the one or more processors as recited in claim 15, in which said shape further comprises a sphere and a cone.

17. The program instructing the one or more processors as recited in claim 13, in which said fourth three dimensional object further comprises a generally cylindrical shape.

18. The program instructing the one or more processors as recited in claim 12, in which said selecting of said second three dimensional object further enables a second animating at least comprising a rotation about one or more other axis, and a selecting of said third three dimensional object further enables a second animating at least comprising a rotation about one or more other axis.

19. The program instructing the one or more processors as recited in claim 13, in which a selecting of said fourth three dimensional object further enables a second animating at least comprising a rotation about one or more other axis.

20. The program instructing the one or more processors as recited in claim 12, in which said text area further comprises three dimensional text further being operative for interacting, said interacting at least comprising being selectable.
